(19) United States
(12) Patent Application Publication
(10) Pub. No.: US 2025/0033537 A1
(43) Pub. Date: Jan. 30, 2025

(54) AUTOMATIC CHILD SEAT ATTACHMENT SYSTEM

(71) Applicant: Tesla, Inc., Austin, TX (US)

(72) Inventors: Andrew Robert Squires, Holland, MI (US); Chris Hill, Jenison, MI (US); Aditya Belwadi, San Jose, CA (US); Forest Wen Liau, Palo Alto, CA (US)

(21) Appl. No.: 18/717,149

(22) PCT Filed: Dec. 6, 2022
(86) PCT No.: PCT/US2022/052006

§ 371 Date: Jun. 6, 2024

Related U.S. Application Data
(60) Provisional application No. 63/265,115, filed on Dec. 8, 2021.

(51) Int. Cl. B60N 2/26; B60N 2/005

(52) U.S. Cl. CPC B60N 2/26; B60N 2/005

(57) ABSTRACT

An attachment system is provided to automatically engage and secure a child seat or other removable items to a vehicle seat. The system includes an actuator configured to moves one or more anchors between retracted and extended positions to engage hooks or other attachment on a child seat. A physical switch can activate the actuator to move the anchors. A controller can be configured to control the actuator based at least in part on trigger signal or tension information coming from a sensor. A processing component can be configured to enable wired or wireless communication to monitor various conditions of the child seat or determine operational parameters of the system.

### CROSS-REFERENCE TO RELATED APPLICATIONS

This application claims the benefit of U.S. Provisional Application No. 63/265,115, filed Dec. 8, 2021, the entire disclosure of which is hereby incorporated by reference in its entirety.

### TECHNICAL FIELD

This application relates to a safety system for a vehicle seat. More particularly, the safety system actuates and monitors attachments for a child seat or other removable item in the vehicle to simplify and ensure safe and secured installation.

### BACKGROUND

Generally described, a variety of forward and rearward facing child seats can be installed in a vehicle. More specifically, latches and tethers on a vehicle seat can be configured to secure the child seat in place. Many countries around the world have standardized how a child seat is to be secured to a vehicle seat and how movement of the car seat is controlled in the event of an impact to improve the overall safety of children's car seats in vehicles. In the U.S., the interconnection of the child seat to the vehicle seat employs a system called Lower Anchors and Tethers for Children (LATCH). LATCH employs two lower anchor attachments and a top tether. In Europe, a similar system for interconnecting the child seat to the vehicle seat is called ISOFIX.

Although current interconnection systems are well designed on paper, the level of safety provided by the systems is heavily dependent on whether the child seat is properly installed in the vehicle and whether the proper installation is maintained over time. Child seat installation is often physically difficult and can be confusing for users. Studies show that a high rate of mis-installation exists with child seats in vehicles. There is a need to improve the interconnection between the child seat and the vehicle to improve the level of safety provided to the child in the event of an impact.

### SUMMARY

The disclosure relates generally to child restraint and safety devices. More specifically, the present disclosure relates to a system for securing and maintaining securement of a child seat or other removable items to a vehicle seat.

An aspect is directed to a system for mounting a child seat or another removable item in a vehicle. The removable item comprises a first hook and a second hook. The system comprises a first lower anchor configured and arranged to connect to the first hook and being movable between a retracted position and an extended position and a second lower anchor configured and arranged to connect to the second hook and being movable between a retracted position and an extended position.

A variation of the aspect above further comprises a seat and a seatback of the vehicle, wherein the first lower anchor and the second lower anchor are at least partially disposed between the seat and seatback when in the extended and retracted positions.

A variation of the aspect above further comprises a switch configured to be activated by a user, wherein activation of the switch moves at least one of the first lower anchor or the second lower anchor between the extended and retracted positions.

A variation of the aspect above further comprises a controller, the controller being configured to move at least one of the first lower anchor or the second lower anchor between the extended and retracted positions.

A variation of the aspect above further comprises a tether anchor, the tether anchor being configured to secure a strap extending from the removable item.

A variation of the aspect above further comprises an actuator configured to move at least one of the first lower anchor or the second lower anchor between the retracted position and the extended position.

A variation of the aspect above is, wherein the actuator is a gear drive actuator.

A variation of the aspect above is, wherein the actuator is a linear actuator.

A variation of the aspect above is, wherein the actuator is an electromechanical solenoid.

A variation of the aspect above further comprises a seat and a seatback of the vehicle, wherein at least a portion of the actuator is disposed below the seat.

A variation of the aspect above is, wherein each of the first lower anchor and the second lower anchor comprises a wire having a curved shape about an axis.

A variation of the aspect above is, wherein the axis is perpendicular to a direction of travel for the first and second lower anchors when moving between the retracted and extended positions.

A variation of the aspect above is, wherein the controller is configured to move at least one of the first or second lower anchors from the retracted position to the extended position for engaging with the respective first or second hook and then, once engaged, begin moving the at least one of the first or second lower anchors along with the engaged first or second hook towards the retracted position so as to secure the removable item to the vehicle.

A variation of the aspect above is, wherein the controller moves the at least one of the first lower anchor or the second lower anchor based at least in part on a trigger signal.

A variation of the aspect above is, wherein the trigger signal is provided by a smartphone.

A variation of the aspect above is, wherein the trigger signal is provided by the vehicle.

A variation of the aspect above is, wherein the trigger signal is provided by the removable item.

A variation of the aspect above further comprises a processing component configured to connect to the removable item.

A variation of the aspect above is, wherein the processing component can receive and transmit information via a power and/or data connection.

A variation of the aspect above is, wherein the processing component is wired or wireless.

A variation of the aspect above is, wherein the processing component is used to monitor temperature and/or dampness of the removable item.

A variation of the aspect above is, wherein the processing component is used to determine operational parameters.

A variation of the aspect above further comprises a sensor configured to sense tension on the first lower anchor or the second lower anchor when at least engaged to the respective first hook or second hook.

A variation of the aspect above is, wherein the controller is further configured to determine whether the first lower anchor and/or the second lower anchor child are tightly attached to the first and second hooks of the removable item, respectively, based at least in part on the sensed tension.

A variation of the aspect above is, wherein the controller is configured to further retract the first lower anchor and/or the second lower anchor based on the sensed tension.

A variation of the aspect above is, wherein the controller is configured to generate a status signal indicative of the tension.

A variation of the aspect above is, wherein the status signal is provided to the vehicle.

A variation of the aspect above is, wherein the status signal is provided to a user of the vehicle.

A variation of the aspect above is, wherein the status signal is provided to an owner of the vehicle.

A variation of the aspect above is, wherein the controller is configured to periodically determine whether the first lower anchor and/or the second lower anchor child are tightly attached to the first and second hooks of the removable item, respectively.

A variation of the aspect above is, wherein the controller is configured to continually determine whether the first lower anchor and/or the second lower anchor are tightly attached to the first and second hooks of the removable item, respectively.

An aspect is directed to a method for securing a child seat or another removable item to a vehicle seat. The method comprises extending one or more anchors from the vehicle seat to engage with the removable item and retracting the one or more anchors to create tension between the one or more anchors and the removable item.

An aspect is directed to a method for securing a child seat or another removable item to a vehicle seat. The method comprises receiving a trigger signal, moving an anchor from a retracted position to an extended position based on the trigger signal, engaging the anchor with the removable item, and moving the anchor towards the retracted position.

A variation of the aspect above further comprises measuring a tension on the anchor when the anchor is engaged with the removable item.

A variation of the aspect above further comprises generating a status signal indicative of the tension.

A variation of the aspect above further comprises moving the anchor towards the extended position if a value of the tension is less than a predetermined value.

An aspect is directed to an automated system for mounting a child seat or another removable item in a vehicle. The removable item comprises a first hook and a second hook. The vehicle comprises a seat and a setback. The system comprises a first lower anchor configured and arranged to connect to the first hook and being movable between a retracted position and an extended position, a second lower anchor configured and arranged to connect to the second hook and being movable between a retracted position and an extended position, and an actuator configured to move at least one of the first lower anchor or the second lower anchor between the retracted position and the extended position. The first lower anchor and the second lower anchor are at least partially disposed between the seat and seatback when in the extended and retracted positions.

A variation of the aspect above further comprises a switch configured to be activated by a user, wherein activation of the switch causes the actuator to move at least one of the first lower anchor or the second lower anchor between the extended and retracted positions.

A variation of the aspect above further comprises a controller configured to control movement of at least one of the first lower anchor or the second lower anchor between the extended and retracted positions.

A variation of the aspect above further comprises a tether anchor configured to secure a strap extending from the removable item.

### BRIEF DESCRIPTION OF THE DRAWINGS

The present disclosure is described with reference to the accompanying drawings, in which like reference characters reference like elements, and wherein:

FIG. 1 is a block diagram of a system for securing a child seat to a vehicle seat according to an embodiment of the present disclosure.

FIG. 2A is an exemplary view of a rearward facing child seat attached by the system of FIG. 1 to the vehicle seat.

FIG. 2B includes perspective views of the system of FIG. 1 with the child seat removed to show one or more anchors of the system in a retracted position and an extended position.

FIG. 3A is an exemplary illustration of the vehicle seat from FIG. 2A.

FIG. 3B is a cross section view of the actuator positioned under the vehicle seat from FIG. 3A.

FIG. 4 is a side view of an assembly that includes the anchor and the actuator from FIG. 1 with the anchor in the retracted position.

FIG. 5 is an opposite side view of the assembly in FIG. 4.

FIG. 6 is a side perspective view of the assembly in FIG. 4.

FIG. 7 is an opposite side perspective view of the assembly in FIG. 4.

FIG. 8 is a top side view of the assembly in FIG. 4.

FIG. 9 is a cross section view taken along lines B-B in FIG. 8 showing the anchor in the retracted position.

FIG. 10 is similar to FIG. 9 except the anchor has been moved to the extended position.

FIG. 11 is a cross section view taken along lines A-A in FIG. 8 showing the anchor in the retracted position.

FIG. 12 is a flow chart of an exemplary process performed by the controller from FIG. 1 to move the one or more anchors to an extended position for engaging the hooks of the child seat and then move the one or more anchors to a retracted position to firmly secure the child seat to the vehicle seat.

FIG. 13A is a perspective view of a child seat attachment system according to another embodiment of this disclosure showing an anchor in an extended position.

FIG. 13B is a perspective view of the system of FIG. 13A showing a LED light lit in green indicating the child seat attachment system has properly secured the child seat.

### DETAILED DESCRIPTION

Generally described, one or more aspects of the present disclosure relate to safety systems for vehicles. In certain embodiments, the disclosure relates to an attachment system that can be configured and arranged to connect to a variety of removable items (e.g. luggage, groceries, electronics, etc.) to enable an removable item or a passenger to be conveniently and securely attached to a vehicle.

Embodiments of the present disclosure can secure apparatus designed for children, generally referred to as child seats or child safety systems. Illustratively, such child seats or child safety systems can include a variety of apparatus/systems, including rear-facing car seats (e.g., Infant Car Seats, Convertible Seats, and All-in-One Seats) and forward-facing car seats (e.g., Convertible Seats, Combination Seats, and All-in-One Seats). Many jurisdictions/regions have laws, regulations or administrative procedures in which safety systems must be incorporated into a vehicle based on the age, height, weight, or combination of individual passengers. For example, most jurisdictions have laws requiring certified safety seats/systems for usually infants or children under or around the age of 8 that are passengers in a vehicle.

Prior approaches include anchors in conformance with regulatory standards on a vehicle seat that are fixed in positions. Installation of child seats on such fixed anchors can often be insecure or incorrect. Other approaches include safety systems that have to be mounted on a vehicle seat to receive a child seat. Such safety systems further obfuscate the latching mechanisms and often requires semi-permanent installation of the system on a vehicle seat and dedicating the seat position to the use of a specific child seat.

Advantages of the child seat attachment system can include ease of use. For example, the system can include self-presenting attachments (e.g., anchors) and confirm correct fit and safety. In certain embodiments, the child seat attachment system removes the need for a child seat base. In this way, the system can off-load the weight and cost of the child seat base to be instead incorporated into the vehicle seat. The system can confirm correct use including, in certain embodiments, electromechanical verification, child seat to vehicle verification, child to child seat verification, and/or child status. In certain embodiments, the system can monitor the child (e.g., heart rate, moisture, and/or picture of face).

The child seat attachment system can include one or more anchors that can be moved between a retracted position and an extended position to enable convenient and secured attachment of a child seat. In certain embodiments, an actuator is configured to move the one or more anchors between the retracted position and the extended position.

In certain embodiments, the child seat is attached to a rear seat (e.g., a seat and a seatback) of the vehicle. In certain embodiments, the one or more lower anchors can be disposed in a gap or slot between the seat and the seatback of the rear seat. In certain other embodiments, the one or more lower anchors can be disposed in the seat of the rear seat so as to be accessible by the user at least when in the extended position.

In certain embodiments, one or more of the anchors are configured as a tether anchor. In certain embodiments, the tether anchor is configured to secure a top tether extending from the child seat.

In certain embodiments, the system can include a switch. In certain embodiments, the switch can be activated by a user or by other means to cause the one or more anchors to move between the extended and retracted positions.

In certain embodiments, the child seat attachment system can include a controller that is configured to move the one or more anchors between the retracted position and the extended position to ease engagement of the one or more anchors to the attachment parts on the child seat (e.g. hooks). In certain embodiments, after engaging the hooks or another kind of attachment parts of the child seat, the controller can further move the one or more anchors along with the engaged hooks or another kind of attachment parts of the child seat towards the retracted position so as to firmly secure the child seat to the vehicle. In certain embodiments, the controller moves the anchors based at least in part on a trigger signal. Such trigger signal can be provided by a trigger source, for example, a smartphone, the vehicle, or the child seat itself.

In certain embodiments, the child seat attachment system can further include a power and/or data connection configured to connect to the child seat. In some embodiments, information generated from various sensors, cameras, integrated components, etc., can be provided to a processing component via a power and/or data connection. Illustratively, such a processing component, such as in the child safety system or vehicle, can process attributable to various conditions (e.g. temperature, dampness, etc.) of the child seat. In certain embodiments, the processing component can further transmit and provide the processed information to the vehicle, a user, or an owner of the vehicle through wire or wirelessly.

In certain embodiments, the system can comprise one or more sensors configured to sense tension applied on the one or more anchors when the one or more anchors are engaged to the hooks or another kind of attachment part of the child seat. In certain embodiments, the controller can receive tension information from the sensor and determine, periodically or continually, whether the one or more anchors are experiencing a sufficient level of tension that maintains the child seat firmly against the seat. For example, in certain embodiments, the controller can further retract the one or more anchors (along with the engaged hook) even after the initial installation of the car seat based on the sensed tension. The further retraction of the one or more anchors can increase the tension to a level which sufficiently secures the child seat to the vehicle.

In certain embodiments, the controller can be configured to generate a status signal (numeric value, level, color code, etc.) indicative of the real time tension and provide the status signal to the vehicle, the user, an owner of the vehicle, and the like. The user or owner of the vehicle can then act, based on the status signal, to make sure that the child seat is securely attached to the vehicle.

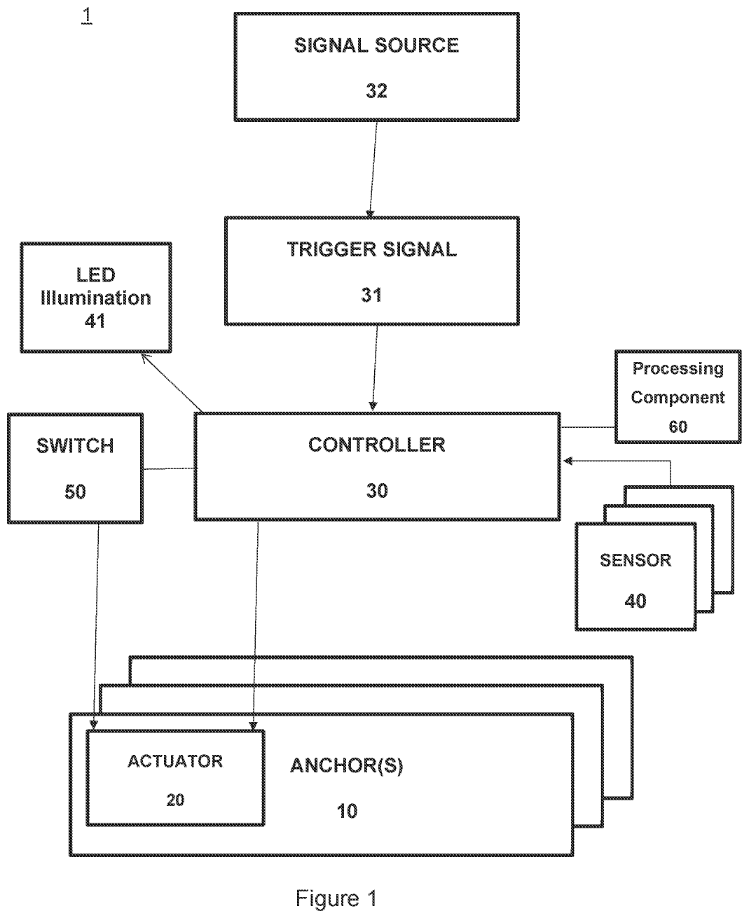

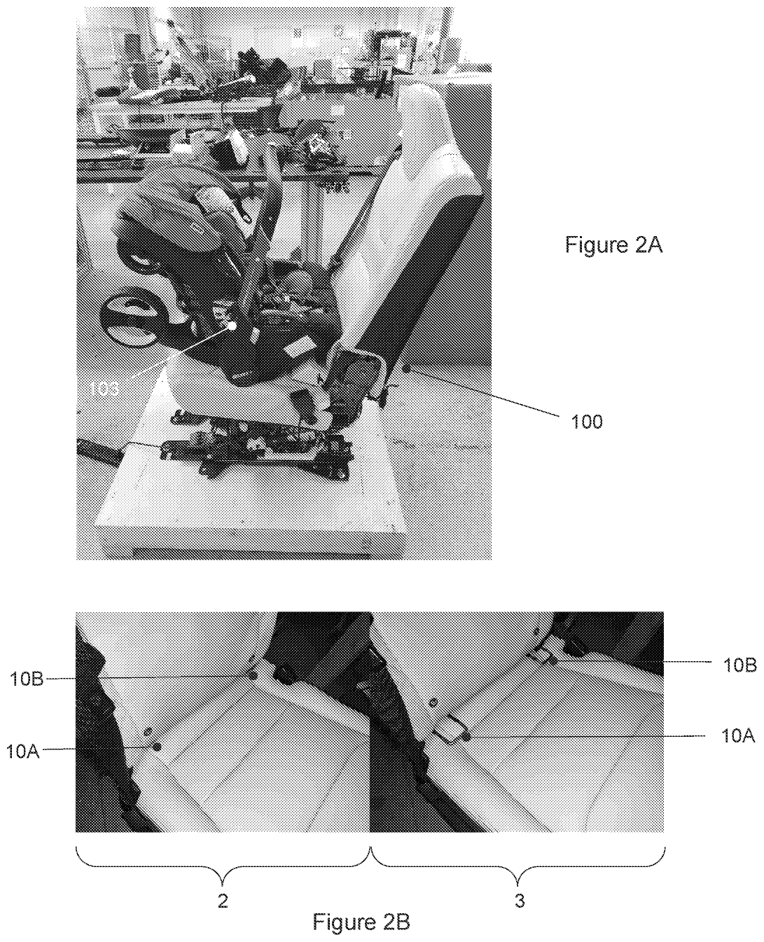

FIG. 1 is a block diagram of a child seat attachment system 1 that is configured to move one or more anchors 10 between a retracted position 2 and an extended position 3. The system 1 can be incorporated into a variety of vehicle seats 100 for securing a variety of different child seats 103. For example, embodiments of the child seat attachment system 1 can secure many types of child seats including rear-facing car seats (e.g., Infant Car Seats, Convertible Seats, and All-in-One Seats) and forward-facing car seats (e.g., Convertible Seats, Combination Seats, and All-in-One Seats). For example, FIG. 2A includes a perspective view of an exemplary rearward facing child seat 103 connected to a vehicle seat 100, and FIG. 2B shows perspective views of the vehicle seat 100 with the child seat 103 removed.

The system 1 comprises one or more anchors 10. In certain embodiments, the one or more anchors 10 comprise a first lower anchor 10A and a second lower anchor 10B. In certain embodiments, the first lower anchor 10A and the second lower anchor 10B move between a retracted position 2 and an extended position 3 and can stay at any point between the retracted position 2 and the extended position 3.

As shown in FIG. 1, in certain embodiments, the system 1 can include one or more actuators 20. The actuator 20 can be of any type (e.g., a gear drive actuator, a linear actuator, an electromechanical solenoid, etc.). In certain embodiments, the actuator 20 is configured to move at least one of the lower anchors 10A, 10B between the retracted position 2 and the extended position 3. In certain embodiments, each actuator 20 is associated with a respective anchor 10. The actuator 20 is configured to move at least one of the lower anchors 10A, 10B between the retracted position 2 and the extended position 3.

As shown in FIG. 1, in certain embodiments, the system 1 can include a switch 50. In certain embodiments, activation of the switch 50 causes the actuator 20 to move at least one of the lower anchors 10A, 10B between the retracted position 2 and the extended position 3. In certain embodiments, the switch 50 is configured to be activated by a user.

In certain embodiments, the system 1 can include a controller 30. In certain embodiments, the controller 30 is configured to move at least one of the lower anchors 10A, 10B between the retracted position 2 and the extended position 3. In certain embodiments, the controller 30 can be configured to receive a trigger signal 31. In certain embodiments, the trigger signal 31 is provided by a signal source 32. In certain embodiments, the controller 30 moves at least one of the lower anchors 10A, 10B between the retracted position 2 and the extended position 3 in response to receiving the trigger signal 31 from the signal source 32. In certain embodiments, the signal source 32 can be a smartphone or smart device, input components associated with the vehicle (e.g., touch screen interfaces, microphones, vision system, pressure sensing system, etc.), or the child seat 103 itself. In some embodiments, for example, as a user is approaching a vehicle implementing the system 1 with a child seat 103, the controller 30 may receive a trigger signal 31 from a signal source 32 (e.g., a smartphone connected to the child seat or the child seat itself) through Bluetooth® or other wireless means. Upon receiving the trigger signal 31, the controller 30 may control the actuator 20 to move at least one of the lower anchors 10A, 10B from the retracted position 2 to the extended position 3. The controller 30 can control the anchors 10A, 10B to automatically extend such that the anchors 10A, 10B are ready for attachment of the child seat 103 by the time the user opens the vehicle door.

In certain embodiments, the system 1 can further include one or more sensors 40. The one or more sensors 40 can include image sensors, temperature sensors, humidity sensors, or any other sensors. The controller 30 can receive information from the one or more sensors 40 and transmit the information to a processing component 60 for processing or directly to a user or an external device for monitoring/processing. In certain embodiments, for example, the controller 30 can receive video data from an image sensor and transmit the video data to a smart device in real-time or periodically so that a user can monitor a child's status in the child seat 103 of the system 1. In certain embodiment, the one or more sensors 40 can be configured to sense tension between the one or more anchors 10 and the child seat 103. For example, in certain embodiments, the controller 30 receives tension information from the sensor 40. In certain embodiments, the controller 30 can further determine whether the one or more anchors 10 are tightly attached to the hooks or another kind of attachment part of the child seat 103. In certain embodiments, the controller 30 can be configured to determine the tightness (e.g., tension) of the attachment between the child seat 103 and the vehicle seat 100 on a periodic or continual basis. In certain embodiments, the tightness is determined in real time.

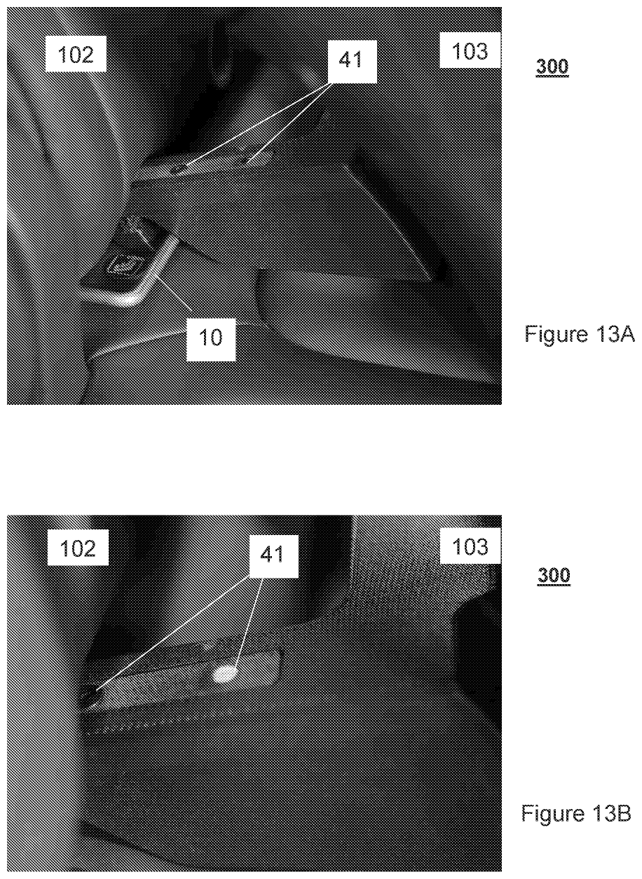

In certain embodiments, the controller 30 can further generate a status signal indicative of the tightness or completeness of the attachment. In some embodiments, the child seat attachment system 1 can include LED illumination configured to indicate whether the child seat 103 has been securely attached. For example, as shown in FIGS. 13A and 13B, the controller 30 can be configured to control LED lights 41 to indicate whether the child seat 103 has been properly attached (e.g., based on sensed tension) to the vehicle seat 100 according to a color code (e.g., LED turning green if properly attached as shown in FIG. 13B).

In certain embodiments, the controller 30 is configured to further retract the anchors 10 and tighten the attachment (e.g., increase tension) between the child seat 103 and the vehicle seat 100 based on the tension sensed by the one or more sensors 40. In certain embodiments, the controller 30 is configured to generate a status signal indicative of the tension. The status signal can be provided to the vehicle, or to a user or owner of the vehicle.

In certain embodiments, the system 1 can further include a processing component 60 configured to connect to the child seat 103. One or mor processing components can receive or measure data provided through power and/or data connection to monitor various conditions (e.g. temperature, dampness, etc.) of the child seat 103 or determine operational parameters associated with use of the system 1. In certain embodiments, condition information can be collected by one or more sensors and/or cameras. In some embodiments, the processing component 60 can be wired or wireless, thereby enabling the condition information to be transmitted to, for example, a smartphone, the vehicle, or a user or owner of the vehicle. In certain embodiments, the processing component 60 connects to the controller 30. In certain embodiments, the processing component 60 is a separate unit.

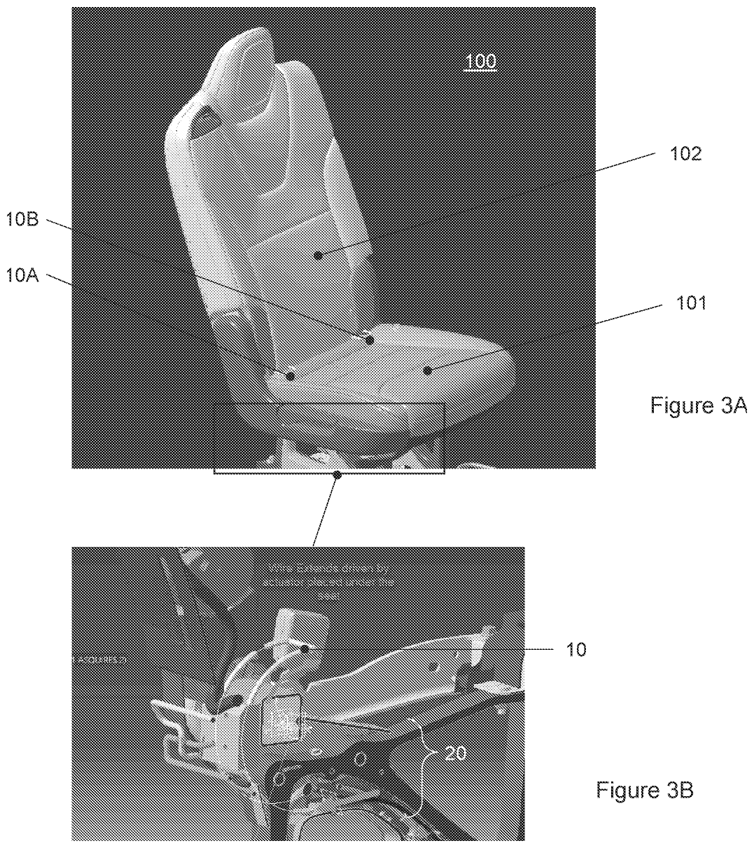

FIG. 3A is an exemplary illustration of the vehicle seat 100 from FIG. 2A; and FIG. 3B shows a cross section view through the actuator 20. The vehicle seat 100 comprises a seat 101 and a seatback 102. As shown in FIG. 3A, in certain embodiments, the actuator 20 can be at least partially disposed under the seat 101. In certain embodiments, the one or more anchors 10 can be partially disposed between the seat 101 and the seatback 102 when in the retracted position 2 and the extended position 3. In certain embodiments, each anchor 10 comprises a wire or any other structure sized and shaped to engage with the hooks or another kind of attachment part of the child seat 103. In certain embodiments, each anchor 10 has a curved shape so as to follow a curved path when moving between the retracted and extended positions. In this way, the one or more anchors 10 can also follow a curved path when retracted into the actuator 20 which allows the actuator 20 to have a compact design and packaged below the seat 101.

In certain embodiments, the one or more anchors 10 can include a tether anchor configured to secure a strap extending from the child seat 103.

In certain embodiments, each of the one or more anchors can alternatively be straight wires allowing the anchors to extend and retract along a straight axis. A child seat attachment system employing straight anchors can include a linear actuation system. In some embodiments, the linear actuation system can be positioned behind a vehicle seat instead of below the seat. The system with the linear system may be more suitable for two seats vehicles with nonmoving seats.

In accordance with various embodiments, an attachment system disclosed herein can also be used to secure other removable items. For example, the attachment system can be used to secure a console with various functions (e.g., bag storage, cup holders, table that could unfolds onto adjacent seats, and etc.). The attachment system can also be used to secure a food delivery storage box with optional heating or cooling function. It can be advantageous to also secure a pet carrier using the attachment system disclosure herein. Further, the attachment system can also be used to secure an electric device, for example, an Optimus bipedal bot, to avoid the need for other complicated securing method (e.g., seatbelt) and provide charging function.

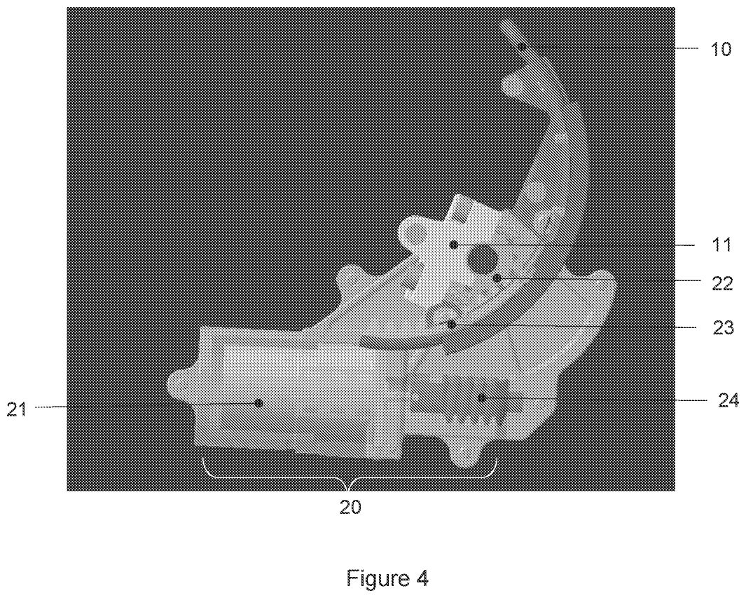

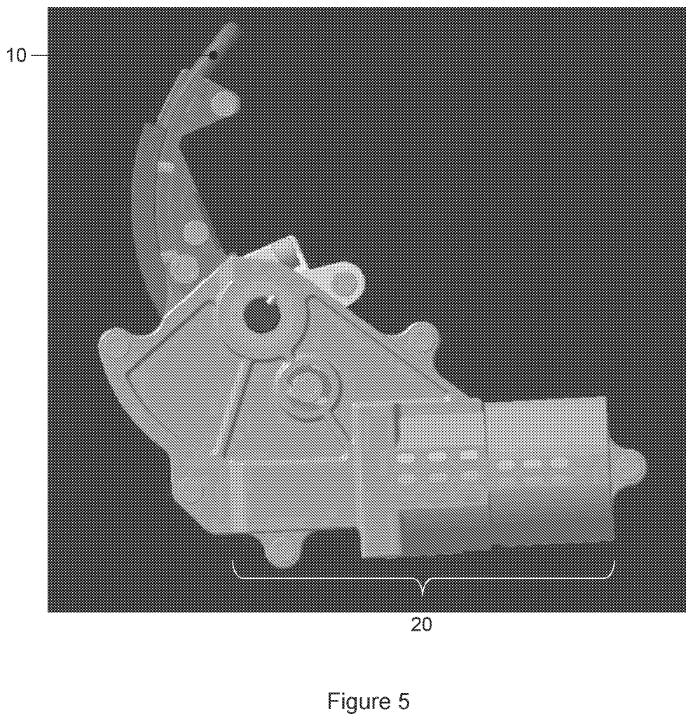

FIG. 4 is a side view of an assembly that includes one of the one or more anchors 10 and an associated actuator 20 from FIG. 1 with the anchor 10 in the retracted position 2. The exemplary embodiment of the actuator 20 shown in FIG. 4 comprises a motor 21, a first gear 22, a gear rack 23, a worm gear 24, and a clamp or housing 11. The clamp or housing 11 can retain the first gear 22. FIG. 5 is an opposite side view of the assembly from FIG. 4 showing the actuator 20 and the anchor 10 in the retracted position 2.

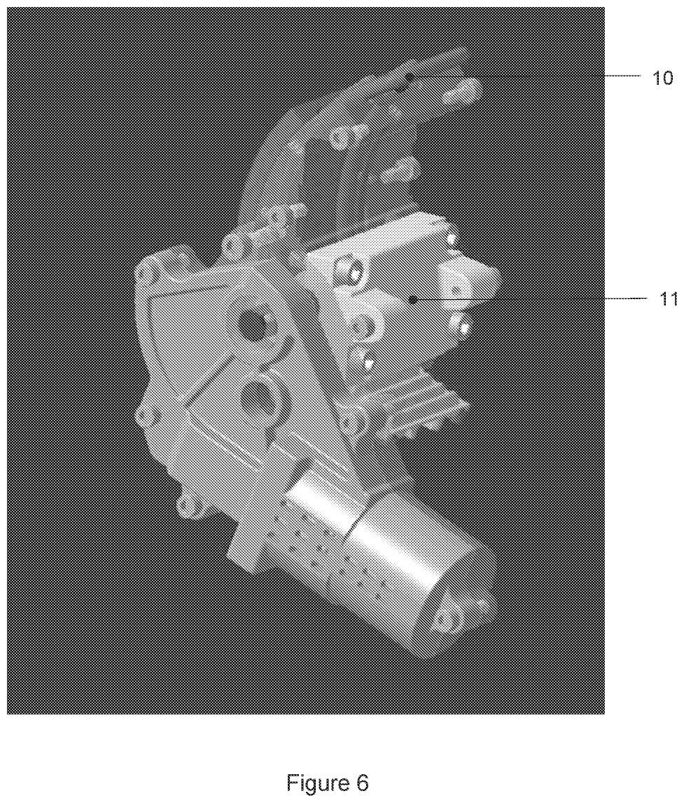

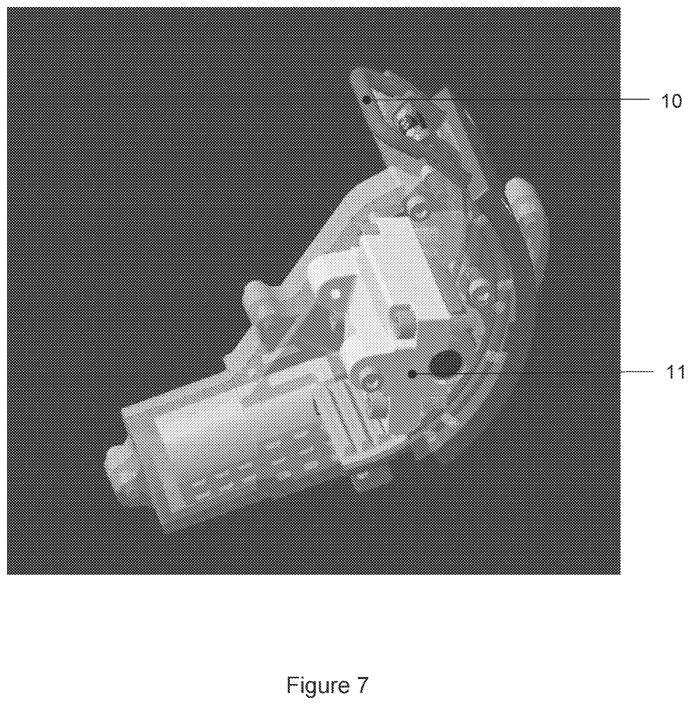

FIG. 6 is a side perspective view of the assembly from FIG. 4 showing the clamp or housing 11 and the anchor 10 in the retracted position 2. FIG. 7 is an opposite side perspective view of the assembly in FIG. 4. In certain embodiments, the actuator 20 can be a gear drive actuator. In certain embodiments, the actuator 20 can be a linear actuator, an electromechanical solenoid, or any other type of actuator.

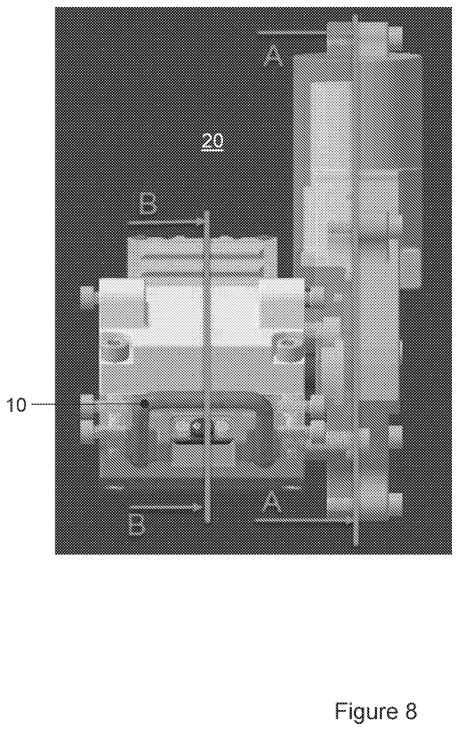

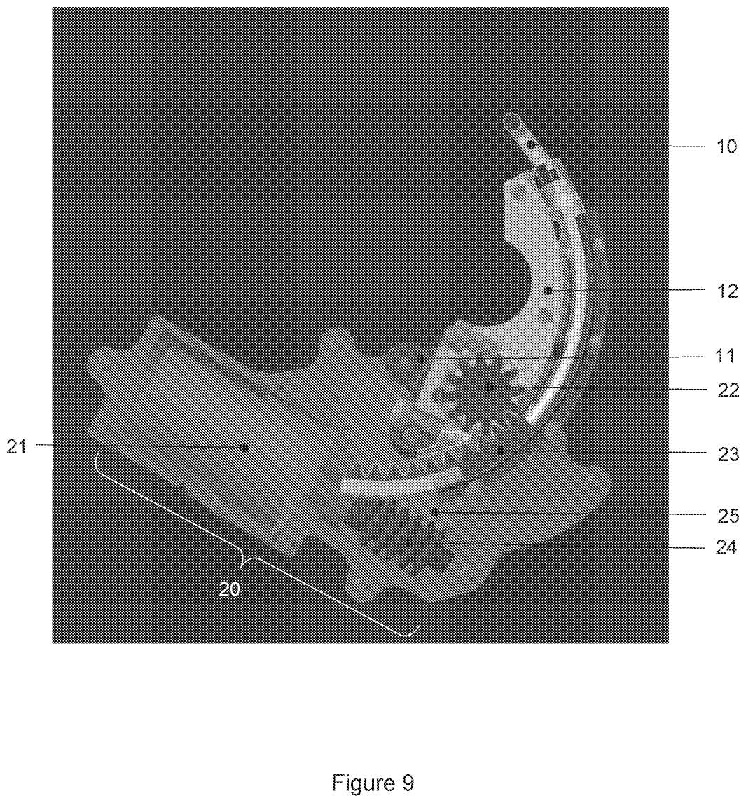

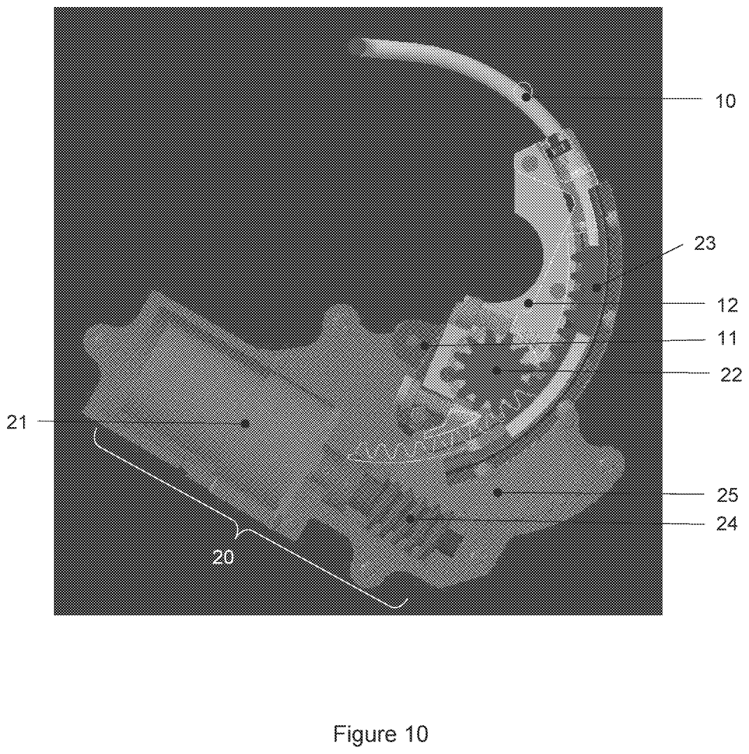

FIG. 8 is a top side view of the assembly in FIG. 4. FIG. 9 is a cross section view along lines B-B in FIG. 8 showing a second gear 25 engaged with the first gear 25 and the anchor 10 engaged with the first gear 22 and gear rack 23 in the retracted position 2. In certain embodiments, the assembly includes a clamp 12 for supporting the anchor 10. FIG. 10 is similar to FIG. 9 except the anchor 10 has been moved to the extended position 3.

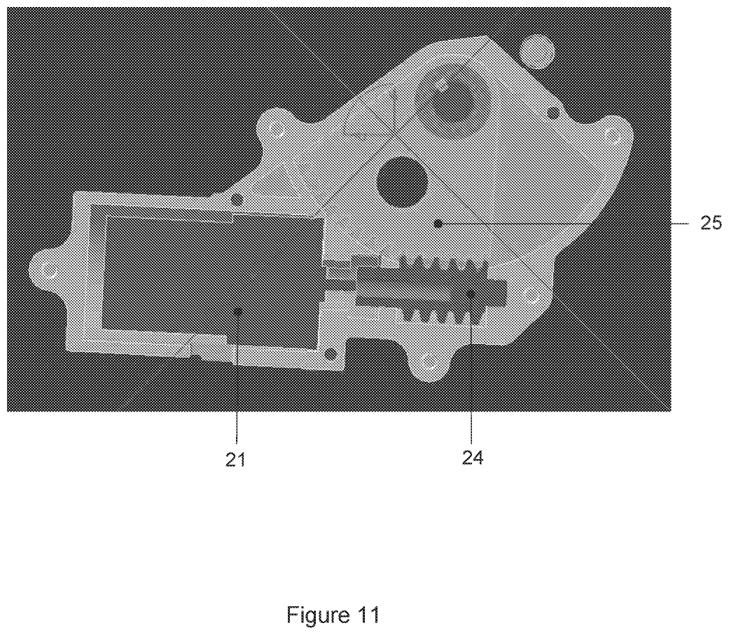

FIG. 11 is a cross section view along lines A-A in FIG. 8 showing the motor 21, the worm gear 24, and the second gear 25 of the actuator 20. In certain embodiments, the motor 21 can move the worm gear 24 which is engaged with the second gear 25, wherein the second gear 25 is engaged with the first gear 22, thereby moving the gear rack 23 and the anchor 10 along with the gear rack 23.

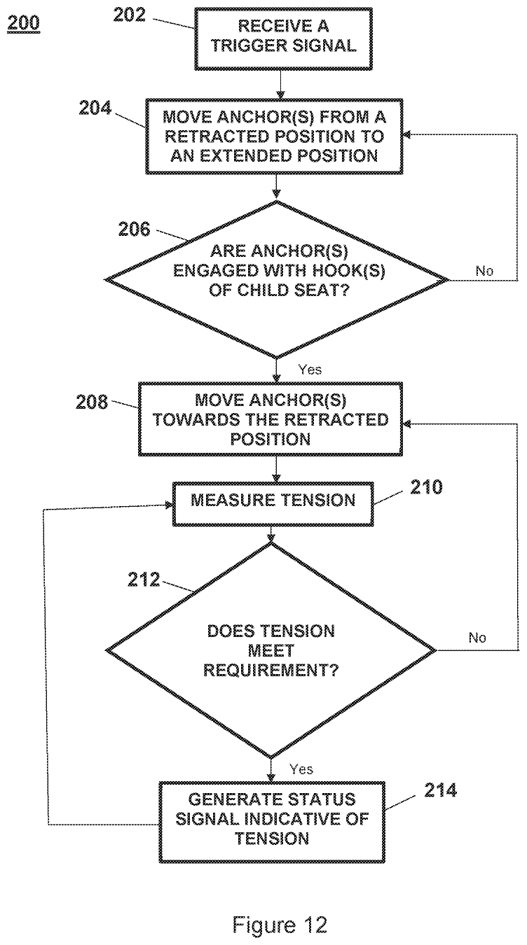

FIG. 12 is a flow chart of an exemplary process 200 performed by the controller 30 from FIG. 1 to move the one or more anchors 10 to an extended position 3 for engaging the hooks or another kind of attachment part of the child seat 103 and then move the one or more anchors 10 to a retracted position 2 to firmly secure the child seat 103 to the vehicle seat 100.

The process 200 may be implemented for each individual actuator 20, such as by the controller 30 configured to receive or provide information on each individual actuator 20 and determine operational parameters for each individual actuator 20. Alternatively, the process 200 may be implemented for a set of actuators 20 located on the vehicle.

At block 202, the controller 30 receives a trigger signal from a smartphone, one or more components of the vehicle, or the child seat 103. For example, in certain embodiments, the vehicle may detect that a child seat 103 is placed on a vehicle seat 100 and send a trigger signal to the controller 30. In other embodiments, the vehicle may detect a user's verbal cue declaring a desire to mount a child seat 103 and send a trigger signal to the controller 30. At block 204, the controller 30 activates the actuator 20 to move anchors 10 from the retracted position 2 to the extended position 3 upon receiving the trigger signal. In the extended position 3, the anchors 10 are ready to be engaged with hooks or another kind of attachment part on the child seat 103. At block 206, the controller 30 determines whether the anchors 10 are engaged with the hooks or another kind of attachment part on the child seat 103. If the controller 30 determines the answer to be yes, the process moves to block 208 where controller 30 can activate the actuator to move the anchors 10 along with the hooks or another kind of attachment part on the child seat 103 towards the retracted position 2 so as to secure the child seat 103 to the vehicle seat 100. If the controller 30 determines the answer to be no, the process returns to block 204 where the engagement process can be repeated.

At block 210, the controller 30 can measure the tension on the anchor 10 when the anchor 10 is engaged to one of the hooks or another type of attachment part on the child seat 103. In certain embodiments, the tension is sensed by the sensor 40. In certain embodiments, the controller 30 receives the tension information from the sensor 40.

At block 212, the controller 30 determines whether the tension meets a predetermined requirement or value. The predetermined requirement or value can be based on a level of tensions that is sufficient for the child seat 103 to be safely installed to the seat 100. If the tension meets the predetermined requirement or value, the process then moves to block 214.

In certain embodiments, at block 214, the controller 30 can generate a status signal indicative of the sensed tension. In certain embodiments, the status signal can be provided to the vehicle, a user, or an owner of the vehicle. A user receiving the status signal will be able to monitor the sensed tension and take remedial steps if the tension falls below a predefined safe value. The process can then return to block 210.

Returning to decision block 212, if the controller 30 determines that the anchors 10 are not tightly attached to the hooks or another kind of attachment part of the child seat 103, the process can return to block 208 where the controller 30 can activate the actuator 20 to further move the anchors 10 towards the retracted position 2 and increase the tension. This feature can ensure that the child seat 103 is tightly secured to the vehicle seat 100 without user's input.

In certain embodiments, the controller 30 can be configured to periodically determine whether the anchors 10 are tightly attached to the hooks or another kind of attachment part of the child seat 103. Alternatively, the controller 30 can be configured to continually determine whether the anchors 10 are tightly attached to the hooks or another kind of attachment part of the child seat 103.

In accordance with various embodiments disclosed herein, another embodiment of a process conducted by the controller 30 of the child seat attachment system 1 may not perform any one or all of blocks 210 to 214 above. The anchors 10 may, after being moved to the retracted position 2, simply stay locked in the retracted position 2 until receiving a trigger signal to go through the process containing block 202, 204, 206, and 208 again as described above.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosed glove box actuation assembly. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other. Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application.

1. A system for mounting a child seat or another removable item in a vehicle, the removable item comprising a first hook and a second hook, the system comprising:
a first lower anchor configured and arranged to connect to the first hook and being movable between a retracted position and an extended position; and
a second lower anchor configured and arranged to connect to the second hook and being movable between a retracted position and an extended position.

2. The system of claim 1, further comprising a seat and a seatback of the vehicle, wherein the first lower anchor and the second lower anchor are at least partially disposed between the seat and seatback when in the extended and retracted positions.

3. The system of claim 1, further comprising a switch configured to be activated by a user, wherein activation of the switch moves at least one of the first lower anchor or the second lower anchor between the extended and retracted positions.

4. The system of claim 1, further comprising a controller, the controller being configured to move at least one of the first lower anchor or the second lower anchor between the extended and retracted positions.

5. The system of claim 1, further comprising a tether anchor, the tether anchor being configured to secure a strap extending from the removable item.

6. The system of claim 1, further comprising an actuator configured to move at least one of the first lower anchor or the second lower anchor between the retracted position and the extended position.

7. The system of claim 6, wherein the actuator is a gear drive actuator.

8. The system of claim 6, wherein the actuator is a linear actuator.

9. The system of claim 6, wherein the actuator is an electromechanical solenoid.

10. The system of claim 6, further comprising a seat and a seatback of the vehicle, wherein at least a portion of the actuator is disposed below the seat.

11. The system of claim 1, wherein each of the first lower anchor and the second lower anchor comprises a wire having a curved shape about an axis.

12. The system of claim 11, wherein the axis is perpendicular to a direction of travel for the first and second lower anchors when moving between the retracted and extended positions.

13. The system of claim 4, wherein the controller is configured to move at least one of the first or second lower anchors from the retracted position to the extended position for engaging with the respective first or second hook and then, once engaged, begin moving the at least one of the first or second lower anchors along with the engaged first or second hook towards the retracted position so as to secure the removable item to the vehicle.

14. The system of claim 13, wherein the controller moves the at least one of the first lower anchor or the second lower anchor based at least in part on a trigger signal.

15. The system of claim 14, wherein the trigger signal is provided by a smartphone.

16. The system of claim 14, wherein the trigger signal is provided by the vehicle.

17. The system of claim 14, wherein the trigger signal is provided by the removable item.

18. The system of claim 1, further comprising a processing component configured to connect to the removable item.

19. The system of claim 18, wherein the processing component can receive and transmit information via a power and/or data connection.

20. (canceled)

21. The system of claim 18, wherein the processing component is used to monitor temperature and/or dampness of the removable item.

22-40. (canceled)
